(19) United States
(12) Patent Application Publication
(10) Pub. No.: US 2009/0043455 A1
(43) Pub. Date: Feb. 12, 2009

(54) Vehicle seatbelt usage technology

(76) Inventors: Fred D. Spooner, Grand Blanc, MI (US); Jessica Lynn Laviolette, Ortonville, MI (US)

Correspondence Address: JOEL D. SKINNER, JR.;SKINNER AND ASSOCIATES, 212 COMMERCIAL ST., HUDSON, WI, 54016, US

(21) Appl. No.: 12/220,534

(22) Filed: Jul. 25, 2008

Related U.S. Application Data
(60) Provisional application No. 60/962,064, filed on Jul. 26, 2007.

(51) Int. Cl. B60R 22/48

(52) U.S. Cl. 701/45

(57) ABSTRACT

An apparatus for indicating or signaling persons or entities outside of a vehicle, for example law enforcement personnel, that one or more occupants of the vehicle are not utilizing their seatbelts. A method of indicating or signaling persons or entities outside of a vehicle that one or more occupants of the vehicle are not utilizing their seatbelts is also disclosed. Methods of use of the apparatus and making the apparatus are also disclosed.

### CROSS-REFERENCE TO RELATED APPLICATIONS, IF ANY

This application claims the benefit under 35 U.S.C. § 119(e) of co-pending US Provisional Patent Application Ser. No. 60/962064, filed Jul. 26, 2007, which is hereby incorporated by reference.

### 37 C.F.R.§1.71(e) AUTHORIZATION

A portion of the disclosure of this patent document contains material which is subject to copyright protection. The copyright owner has no objection to the facsimile reproduction by anyone of the patent document or the patent disclosure, as it appears in the US Patent and Trademark Office patent file or records, but otherwise reserves all copyright rights whatsoever.

### STATEMENT REGARDING FEDERALLY SPONSORED RESEARCH OR DEVELOPMENT

Not applicable.

### REFERENCE TO A MICROFICHE APPENDIX, IF ANY

Not applicable.

### BACKGROUND OF THE INVENTION

1. Field of the Invention.

The present invention relates, generally, to motor vehicle technology, safety technology, indicator or signaling technology, and law enforcement technology. Particularly, the invention relates to a method and apparatus for indicating or signaling persons or entities outside of a vehicle, for example law enforcement personnel, that one or more occupants of the vehicle are not utilizing their seatbelts.

2. Background Information.

Vehicle occupant sensors, seatbelt use sensors, and signal transmission means for such sensors exist. However, insofar as is know, no system exists for alerting law enforcement to the improper use of seat belts. Existing technology is believed to have significant limitations and shortcomings. For this and other reasons, a need exists for the present invention.

All US patents and patent applications, and all other published documents mentioned anywhere in this application are incorporated by reference in their entirety.

### BRIEF SUMMARY OF THE INVENTION

The invention provides a seatbelt usage detection and signaling/indication apparatus and method which is practical, reliable, accurate and efficient, and which is believed to fulfill the need and to constitute an improvement over the background technology.

In one aspect, the invention provides an apparatus and method for indicating or signaling persons or entities outside of a vehicle, for example law enforcement personnel, that one or more occupants of the vehicle are not utilizing their seatbelts.

In one aspect, the apparatus for monitoring seatbelt usage in a vehicle, comprises at least one sensor for detecting the presence of a vehicle occupant associated with each seatbelt of a vehicle, a controller communicatively connected to the at least one sensor and to each seatbelt in the vehicle for detecting use of each such seatbelt, and a signal output device communicatively connected to the controller for outputting a signal indicative of the lack of usage of a seat belt by at least one vehicle occupant.

In other aspects of the apparatus, the signal output device may be an indicator. The indicator may be a visual indicator. The visual indicator may be deployed on the exterior of a vehicle. The visual indicator may be at least one existing vehicle brake light. The signal output device may be communicatively connected to the vehicle drive system and the signal may disable the vehicle drive system.

One aspect, the method of monitoring seatbelt usage in a vehicle, comprises the steps of detecting the presence of a vehicle occupant associated with each seatbelt of a vehicle, detecting whether each occupant is using their associated seatbelt, and outputting a signal indicative of the lack of usage of a seat belt by at least one vehicle occupant.

In other aspects of the method, the signal output may be a percievable indicator. The indicator may be a visual indicator and may be output on the exterior of a vehicle. The visual indicator may be output from at least one existing vehicle brake light. The signal output may disablee the vehicle drive system.

The aspects, features, advantages, benefits and objects of the invention will become clear to those skilled in the art by reference to the following description, claims and drawings.

### BRIEF DESCRIPTION OF THE SEVERAL VIEWS OF THE DRAWING

FIG. 1 is a side or elevation view illustrating an embodiment of the apparatus and method of the present invention.

FIG. 2 is a top or plan view illustrating the apparatus and method of the invention.

FIG. 3 is a schematic diagram of the apparatus and method of the invention.

FIG. 4 is a side or elevation view illustrating an alternative embodiment of the apparatus and method of the present invention.

FIG. 5 is a top or plan view illustrating the apparatus and method of FIG. 4.

FIG. 6 is a schematic diagram of the apparatus and method of FIGS. 4 and 5.

### DETAILED DESCRIPTION

The present invention provides an apparatus and method for indicating or signaling persons or entities outside of a vehicle, for example law enforcement personnel, that one or more occupants of the vehicle are not utilizing their seatbelts. The primary purpose of the apparatus and method is to reduce the number of motor vehicles injuries and/or fatalities caused by driver and/or passenger failure to buckle their seat belts. The apparatus gives a signal or signals, preferably visual, but it could come in another form such as audible or electromagnetic, of failure to buckle, that can be perceived to a person or persons outside the vehicle. The signal or signals could for example indicate failure to buckle, and therefore noncompliance with local, state and/or federal seatbelt or other laws, regulations or rules to law enforcement personnel. Additionally the apparatus and method of the invention could prevent or delay the motor vehicle from functioning or driving if the seatbelt or seatbelts are not buckled.

One embodiment of the apparatus and method of the invention utilizes known technology to detect the number of occupants in a motor vehicle. If the motor vehicle detects that one or more occupants is unbuckled, a signal, for example a visual signal, will be given to law enforcement personnel in the form of the emergency tail light, or other tail light, or visual signal flashing periodically. Which light flashes and at what rate it flashes or if another visual signal or some other form of signal is given to law enforcement will be determined by local, state, and/or federal laws. Another embodiment of the apparatus and method of the invention prevents, delays from starting, or otherwise limits or alters the functionality of the vehicle if one or more occupants are not buckled. Another embodiment of this system utilizes known breathalyzer technology installed in cars prevent drunk driving. This invention could prevent unbuckled driving all together.

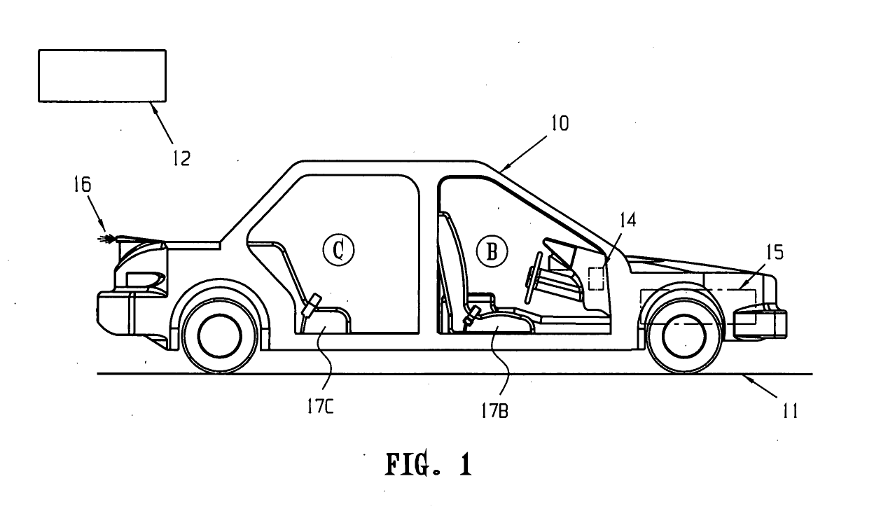

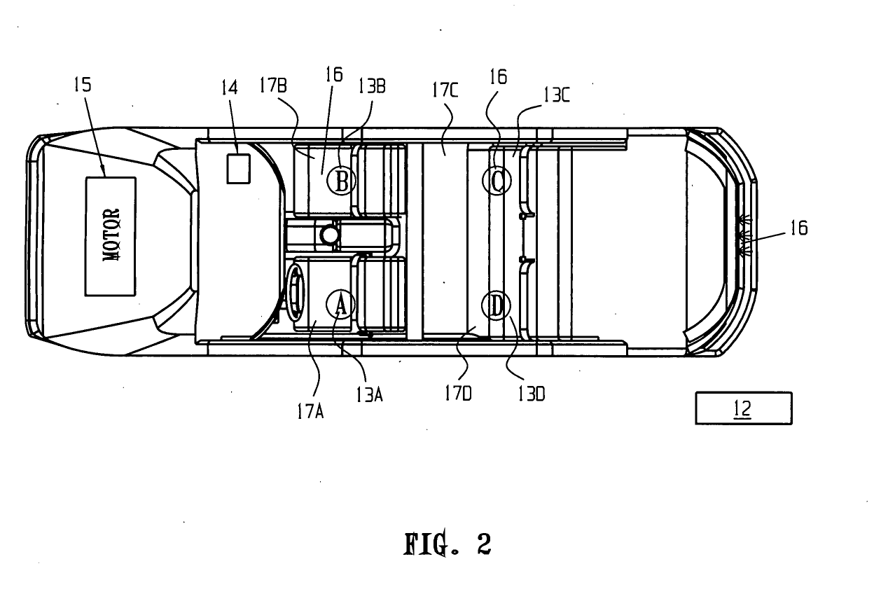

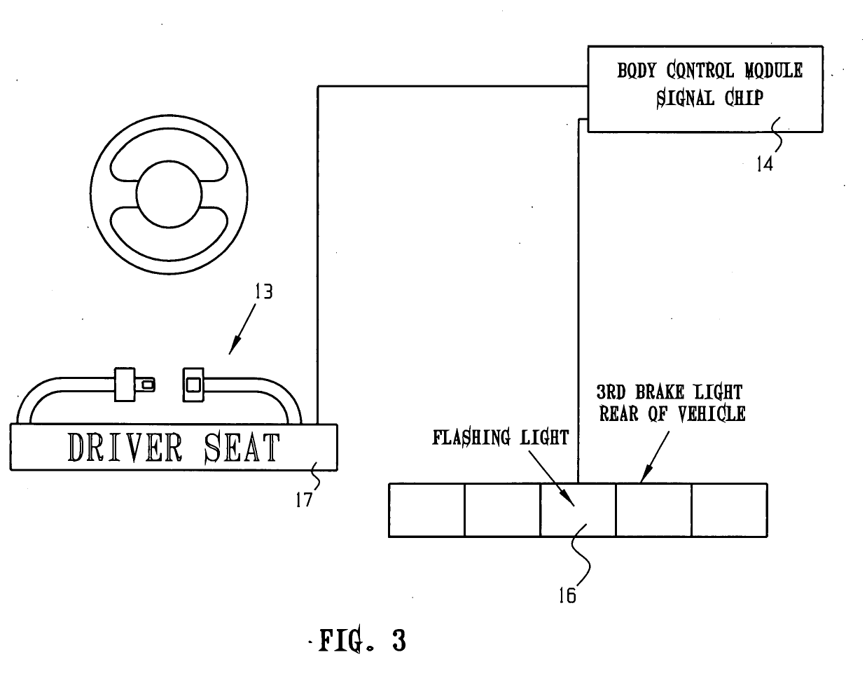

FIGS. 1 to 3 show a motor vehicle 10 traveling on a street, road or highway 11. Occupants A-D, for example, are seated in seats 17 A-D of vehicle 10. Occupant A, the driver for example, is restrained by seatbelt 13A. Occupant B, a passenger, is not utilizing seat belt 13B. Passenger C has properly deployed seatbelt 13C. And passenger D has not actuated seatbelt 13d. The vehicle 10 has a motor or engine 15, which may be gasoline, diesel, electric or hybrid powered. A controller 14 is communicatively connected to the seatbelts 13 via wiring or other signal transmission means and can sense seatbelt actuation. The controller 14 is also preferably communicatively connected to seat sensors 16, of a known type, to detect occupants being seated or not in positions A-D. The controller 14 is preferably electronic, but may be mechanical. The controller 14 is preferably powered by the vehicle 10 electrical system and comprises control, memory and interface components; and may utilize software for instructions.

Upon detection of at least one seat belt not being properly deployed on a seated passenger, the controller actuates communicatively connected center indicator 16, which is preferably disposed on the exterior of the vehicle 10. The indicator 16 signals exterior entity or element 12 of the aforementioned lack of proper usage of the seatbelt. The signal emitted by indicator 16 is a visual signal in this case, but may alternatively be audible, electromagnetic, or a combination thereof. Exterior entity or element may be a law enforcement officer or a sensor, both of which may be moving or stationary.

Controller 14 may be communicatively connected to the motor 15, and may further be configured to prevent all or partial operation of the vehicle 10 upon detecting a failure to properly utilize the seatbelt systems.

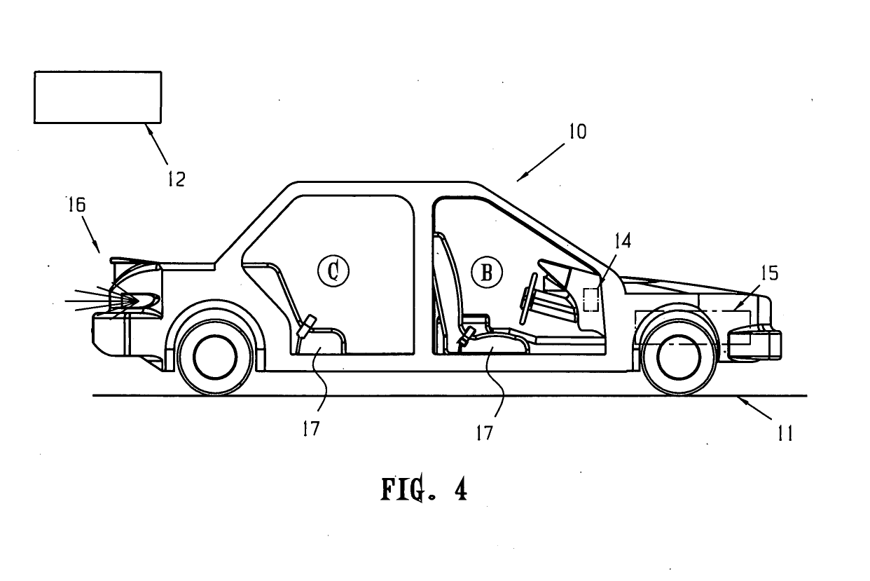

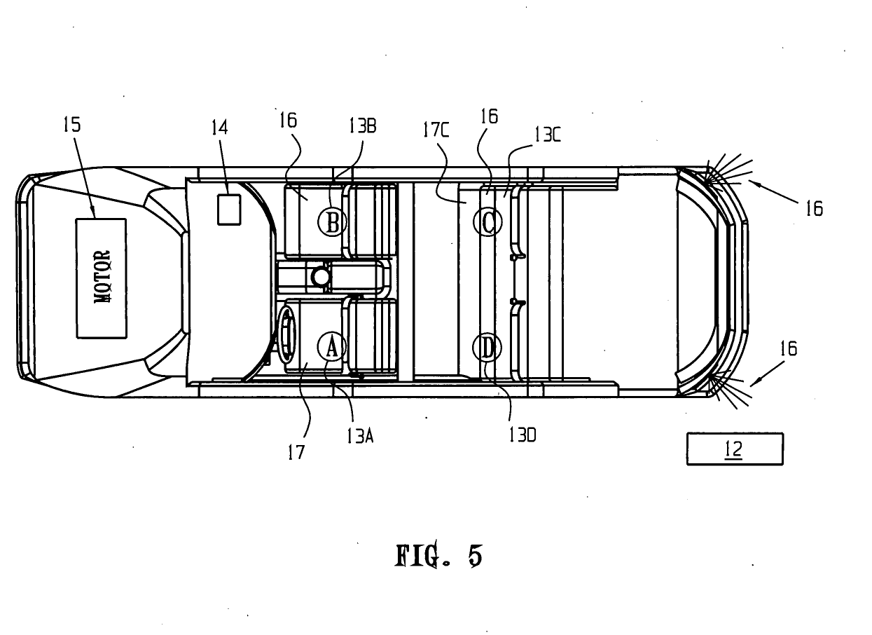

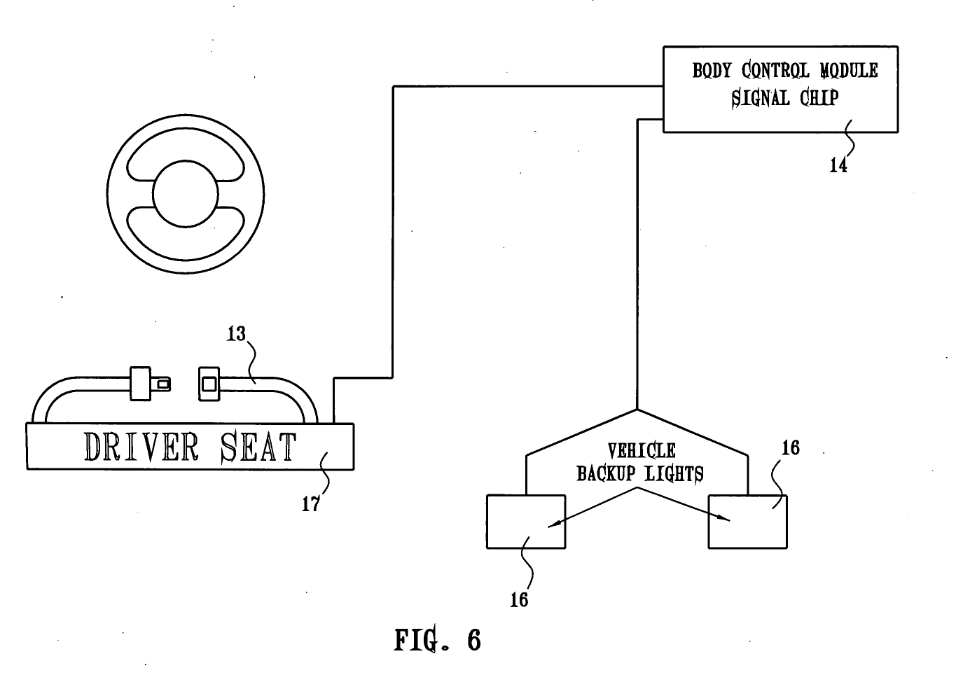

FIGS. 4 to 6 show an alternative embodiment of the apparatus and method of the invention in a motor vehicle 10 with Passenger A restrained by seatbelt, Passenger B is not utilizing seat belt 13B, and Passenger C with a properly deployed seatbelt 13C, and Passenger D has not actuated seatbelt 13d. The system again has a controller 14 is communicatively connected to the seatbelts 13 via wiring or other signal transmission means and can sense seatbelt actuation. The controller 14 is also preferably communicatively connected to seat sensors 16. Upon detection of at least one seat belt not being properly deployed on a seated passenger, the controller actuates communicatively connected to standard vehicle brake lights 16. The brake lights emit a predetermined special pattern of visual, light 16 which is indicative of the aforementioned lack of proper usage of the seatbelt.

This invention builds upon and improves previous technology that allows a motor vehicle to detect the number of occupants in a vehicle and if the driver or passenger seat belts are unbuckled. The invention builds upon this detection technology to give some form of a signal to others, for example law enforcement personnel, or prevents the motor vehicle from starting if one or more passengers or the driver is unbuckled.

The embodiments above are chosen, described and illustrated so that persons skilled in the art will be able to understand the invention and the manner and process of making and using it. The descriptions and the accompanying drawings should be interpreted in the illustrative and not the exhaustive or limited sense. The invention is not intended to be limited to the exact forms disclosed. While the application attempts to disclose all of the embodiments of the invention that are reasonably foreseeable, there may be unforeseeable insubstantial modifications that remain as equivalents. It should be understood by persons skilled in the art that there may be other embodiments than those disclosed which fall within the scope of the invention as defined by the claims. Where a claim, if any, is expressed as a means or step for performing a specified function it is intended that such claim be construed to cover the corresponding structure, material, or acts described in the specification and equivalents thereof, including both structural equivalents and equivalent structures, material-based equivalents and equivalent materials, and act-based equivalents and equivalent acts.

The invention claimed is:

1. An apparatus for monitoring seatbelt usage in a vehicle, comprising: at least one sensor for detecting the presence of a vehicle occupant associated with each seatbelt of a vehicle, a controller communicatively connected to the at least one sensor and to each seatbelt for detecting use of each such seatbelt, and a signal output communicatively connected to the controller for outputting a signal indicative of the lack of usage of a seat belt by at least one vehicle occupant.

2. The apparatus of claim 1 wherein the signal output is an indicator.

3. The apparatus of claim 2, wherein the indicator is a visual indicator.

4. The apparatus of claim 3, wherein the visual indicator is deployed on the exterior of a vehicle.

5. The apparatus of claim 3, wherein the visual indicator is at least one existing vehicle brake light.

6. The apparatus of claim 1, wherein the signal output is communicatively connected to the vehicle drive system and wherein the signal disables the vehicle drive system.

7. The apparatus of claim 1, further comprising a power supply connected to the controller.

8. A method of monitoring seatbelt usage in a vehicle, comprising the steps of: detecting the presence of a vehicle occupant associated with each seatbelt of a vehicle, detecting whether each occupant is using their associated seatbelt, and outputting a signal indicative of the lack of usage of a seat belt by at least one vehicle occupant.

9. The method of claim 8 wherein the signal output is a percievable indicator.

10. The method of claim 9, wherein the indicator is a visual indicator.

11. The method of claim 10, wherein the visual indicator is output on the exterior of a vehicle.

12. The method of claim 10, wherein the visual indicator is output from at least one existing vehicle brake light.

13. The method of claim 8, wherein the signal output disables the vehicle drive system.
